(19) United States
(12) Patent Application Publication
(10) Pub. No.: US 2004/0211834 A1
(43) Pub. Date: Oct. 28, 2004

(54) Systems and methods of modifying item delivery utilizing linking

(75) Inventors: James J. Fleckenstein, Alpharetta, GA (US); Matthew T. Miller, Cumming, GA (US); Craig M. Barta, Alpharetta, GA (US); Daniel Garcia, Norcross, GA (US); Scott Aubuchon, Alpharetta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/848,659

(22) Filed: May 18, 2004

Related U.S. Application Data
(63) Continuation-in-part of application No. 10/646,375, filed on Aug. 20, 2003.
Application No. 10/646,375 is a continuation of application No. 09/815,745, filed on Mar. 23, 2001, now Pat. No. 6,634,551.
(60) Provisional application No. 60/203,402, filed on May 11, 2000.

(51) Int. Cl. G06F 17/60

(52) U.S. Cl. 235/385

(57) ABSTRACT

Generally described, under one aspect of the invention, an indicia associated with a delivery modification authorization left at an intended recipient's first location. This indicia is “linked” to the parcel(s) that were intended for delivery to the first location. This can be done by a handheld portable data acquisition device that includes a scanning or reading means, allowing information to be acquired from the delivery modification authorization as well as from the parcels, and stored on the handheld portable data acquisition device. The indicia is then used to access alternate delivery instructions that have been established by the intended recipient. The alternate delivery instructions are provided to the delivery agent. The parcel(s) are then delivered in accordance with the alternate delivery instructions.

### CROSS-REFERENCES TO RELATED APPLICATIONS

This application is a continuation-in-part of co-pending U.S. patent application Ser. No. 10/646,375, filed on Aug. 20, 2003, which is a continuation of U.S. patent application Ser. No. 09/815,745, filed Mar. 23, 2001, now issued as U.S. Patent No. 6,634,551, which claims benefit of U.S. Provisional Application No. 60/203,402, filed May 11, 2000, all of which are hereby incorporated herein by reference in their entirety and made a part hereof.

### FIELD OF THE INVENTION

The present invention generally relates to delivery of items, and particularly relates to the delivery of items such as parcels (a.k.a. “packages”) from a delivery service provider (hereinafter “delivery service”), to an intended recipient (a.k.a. “consignee”).

### BACKGROUND OF THE INVENTION

The delivery of parcels and other items to the residence of intended recipients is well known in the art. In many instances, when a parcel is undeliverable, a “delivery notice” is left at the particular location, and the intended recipient then has the opportunity to contact the delivery service (e.g., UPS) via telephone or the Internet and arrange to have the package(s) redelivered, held at a local operation center, redirected, or returned. However, the consumer may not know much about the parcel(s) (e.g., who sent it to them) or even how many parcels were undeliverable. The delivery service can use the address of the customer to determine the delivery center location, as well as the truck that serviced the customers' route. The delivery service will then pull the package from the truck (after matching the customer's name with the parcel(s)) and attend to the necessary handling of the parcel.

In other instances, a customer may sign the delivery notice left at an attempted delivery location as a form of authorization to allow the delivery service to leave the parcels unattended at the intended recipient's location. The signed delivery notice is left for the delivery service when the delivery service makes their next delivery attempt. The delivery service will retrieve the signed delivery notice and leave the parcels at the location.

In yet other instances, an intended recipient may want parcels for which delivery has been attempted at a first location, delivered to a second location. Currently, the intended recipient must pre-arrange such modified delivery, or contact the delivery service after an attempted delivery.

As may be understood, such activities are labor intensive.

In light of the above, it may be seen that there is a need in the art to provide an improved method for providing package or other item delivery that is less labor intensive than the methods described above.

### SUMMARY OF THE INVENTION

Generally described, the embodiments of the present invention provide a system for delivering a plurality of unique items each having unique identities and each having a different item code readable therefrom. In one embodiment, the system is comprised of a plurality of delivery notices, each of the delivery notices including a delivery notice code thereon, each of the delivery notice codes being unique within the plurality of delivery notices, a code-reading device configured to read the delivery notice code from one of the delivery notices as well as to read the item code from each of the plurality of items, such that a delivery notice code is read and a plurality of item codes are read; and a code storing device, the device configured to store the delivery notice code and the plurality of item codes. In this manner, the unique identity (i.e., item code) of each unique item is linked with a delivery notice code.

In other embodiments, the item code of each item intended for delivery at a location is linked with another indicia similar to the manner in which the item codes are linked with the delivery notice code, as described above. For instance, in one embodiment the item codes may be linked with an authorization on file indicia that provides pre-approved authorization for the items to be left unattended at the intended recipient's location (i.e., the first location). In yet another embodiment, the item codes are linked to indicia that authorize the items to be delivered to a second location. In some embodiments, the alternate delivery code may provide information indicating the second location for delivery of the items.

Therefore it is an aspect of the present invention to provide a method of delivering parcels, mail or other similar items.

It is a further aspect of the present invention to provide a method of delivering parcels, mail or other similar items that is reliable.

It is a further aspect of the present invention to provide a method of delivering parcels, mail or other similar items that is efficient.

Another aspect of the invention is a method for modifying the delivery of one or more unique items each intended for delivery at a first location and each having a unique identity and each item having a different machine-readable item code. The method includes the steps of providing a delivery modification authorization at the first location having a unique alternate delivery code thereon. The alternate delivery code is read from the delivery modification authorization and then the item code from at least one of the items is read. The alternate delivery code is then linked with the item code. Stored alternate delivery information regarding the item is then read in response to receipt of a description of the delivery modification authorization from a delivery agent. Delivery plans of the item are modified based upon said stored alternate delivery information.

Yet another aspect of the invention is a method for modifying the delivery a plurality of unique items each intended for delivery at a first location and each having a unique identity and each item, having a different machine-readable item code. The method includes the steps of providing a delivery modification authorization at the first location having a unique alternate delivery code. The alternate delivery code is then read from the delivery modification authorization. The item codes from each of the items are then read and the alternate delivery code is linked with the item codes. Stored alternate delivery information regarding the items is then read in response to receipt of a description of said delivery modification authorization. The delivery plans of the items are then modified based upon the alternate delivery information.

Another aspect of the invention is a method of altering the delivery of one or more items each having an item code and each intended for delivery at a first location having a delivery modification authorization with an alternate delivery code. The method comprises transporting the one or more items to the first location and reading the item code from each of said one or more items. The alternate delivery code is then read from said delivery modification authorization and the alternate delivery code is used to access information about the one or more items wherein the information includes alternate delivery instructions for the one or more items. The delivery plans of the one or more items are then modified based upon the alternate delivery instructions.

Another aspect of the invention is a method of an intended recipient providing alternate delivery instructions and authorization to a delivery service for the delivery of one or more items. The method is comprised of the following steps. The delivery service is contacted and provided one or more alternate delivery instructions related to the one or more items intended for delivery to said intended recipient at a first location. The delivery service is then authorized to execute one or more alternate delivery instructions. The intended recipient then receives a delivery modification authorization having at least one indicia from the delivery service. The indicia is associated with at least one of the one or more alternate delivery instructions.

Another aspect of the invention is a computer-readable storage medium containing a database of computer-readable information for modifying the delivery of one or more packages intended for a customer by a delivery service. The database is accessible by a set of computer-executable instructions and contains database records. The database records are comprised of a unique identifier that is associated with a delivery modification authorization, and alternate delivery instructions. A delivery modification authorization identifier is received into a computer device and the computer-executable instructions cause the database to be accessed and searched for a database record having a unique identifier that matches the delivery modification authorization identifier, and if such database record is found then the alternate delivery instructions for that database record are displayed to the delivery service.

Yet another aspect of the invention is a system for modifying the delivery of one or more items each having an item code and each intended for delivery at a first location by a delivery service. The system is comprised of a data acquisition device that reads the item codes from the one or more items. Another element of the system is a delivery modification authorization that is found at the first location. The data acquisition device reads a unique indicia from the delivery modification authorization and electronically links the item codes to the unique indicia. The system is further comprised of a first database that is accessed by said unique indicia, wherein the first database has one or more database records containing alternate delivery instructions indexed by the unique indicia and the alternate delivery instructions associated with said unique indicia are retrieved from the first computer database and displayed on the data acquisition device. The system also has a second computer database where the linked item codes and unique indicia are stored.

[Add Broadest Claim Language]

Other objects, features, and advantages of the present invention will become apparent upon reading the following detailed description of the embodiments of the invention when taken in conjunction with the drawings and the appended claims.

### BRIEF DESCRIPTION OF THE DRAWINGS

FIG. 1 is an illustrative view of a delivery agent 100 holding a plurality of parcels 110, 120, at the door of a typical address 123 Elm Street. As the parcels could not be delivered according to the agent's delivery rules, the agent has obtained information about a delivery modification authorization 400 and the parcels 110, 120. In one embodiment, a delivery notice 20 may be left at the address 123 Elm Street. Such information may be obtained by use of, for example, a data acquisition device 30 that may include a radio frequency identification (“RFID”) reader, a barcode scanner, etc. In an alternate embodiment the intended recipient of the parcel may receive an email from the delivery service at an email address specified by the intended recipient indicating that a delivery has been attempted or that the delivery has been modified.

FIG. 2A is an illustrative view of the various data connections between various elements of an overall system 10 according to an embodiment of the present invention. The system 10 includes a delivery notice 20, a data acquisition device 30 having a scanning/reading element 31, and a server 40. In an alternate embodiment the system can also include a parcel delivery car 50. In another independent alternate embodiment the system can also include an Internet 200 connection or other suitable network connection to provide access to typical computers 300.

FIG. 2B is another illustrative view of the various data connections between various elements of an overall system 202 according to an embodiment of the present invention. The system 202 includes a delivery modification authorization 400, a data acquisition device 30 having a scanning/reading element 31, and a server 40. In an alternate embodiment the system can also include a parcel delivery car 50. In another independent alternate embodiment the system can also include an Internet 200 connection or other suitable network connection to provide access to typical computers 300.

FIGS. 3A and 3B are the first and second sides, respectively, of a delivery notice 20 according to an embodiment of the present invention. The notice in one embodiment is a piece of paper printed on both sides. The first side includes a machine-readable (first) delivery notice code 21, which corresponds to a human-readable (second) delivery notice code 22, which is in this case numerals, although it could be alphanumeric or any human readable format. Also included on the notice 20 is various other self-explanatory text on the notice in areas 23, 24, 25, 26, 27, and 29.

In one embodiment, the machine-readable (first) delivery notice code 21 is the same as the alphanumeric human-readable (second) delivery notice code 22. However, it should be noted that such human-readable and the machine-readable codes do not have to be the same codes, although they do need to be associated or “linked” in order to provide the needed link between the code read by the customer and the notice code scanned by the driver.

In other embodiments the delivery notice may be an RFID tag encoded with machine-readable information. Such an RFID tag delivery notice may be associated with human-readable information that is provided to the intended recipient.

In other embodiments the notice may be information transmitted to the intended recipient through means such as, for example, email, telephone, facsimile, wireless, radio frequency, etc.

FIG. 4 is a delivery modification authorization 400 according to an embodiment of the present invention. The authorization in one embodiment is a placard located at an intended recipient's location. The authorization includes a machine-readable authorization code 402, which corresponds to certain instructions stored in a database that concern the items to be delivered.

FIGS. 5A and 5B are illustrations of exemplary systems and databases for linking an alternate delivery authorization code with a database record having personal profile instructions, in embodiments of the invention.

FIG. 6 is an exemplary data acquisition device that may be used in an embodiment of the invention.

FIG. 7 shows a typical exemplary web page that the customer would see after entering the delivery notice code 22 which the customer read from the notice 20, which in this case is 9110987654321. The page, which could be referenced as the “Tracking Summary” page, shows that the delivery was attempted on May 17, 2000, at 11:25a.m., and that four packages were in the attempted delivery. The customer can use the hyperlink at 702 to view that shown in FIG. 8.

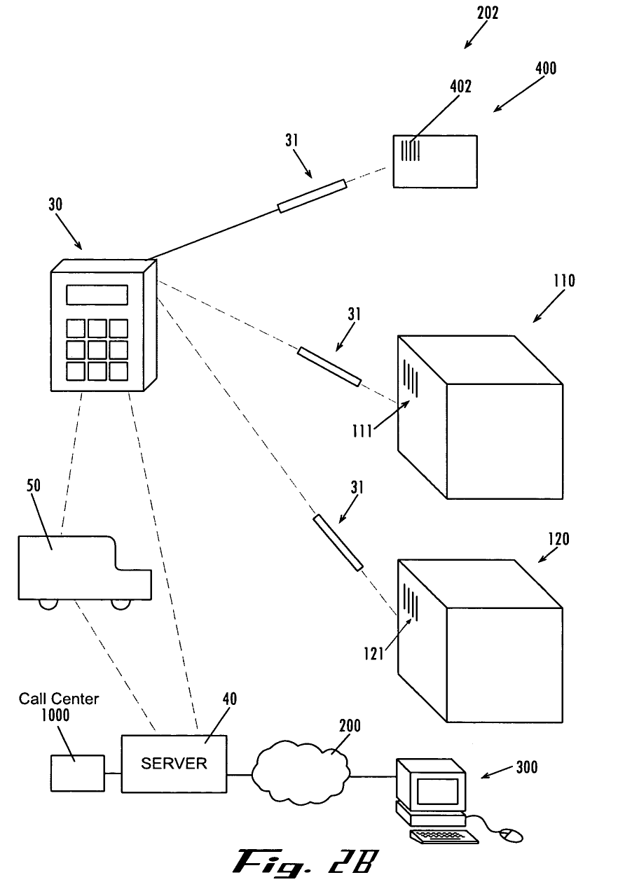

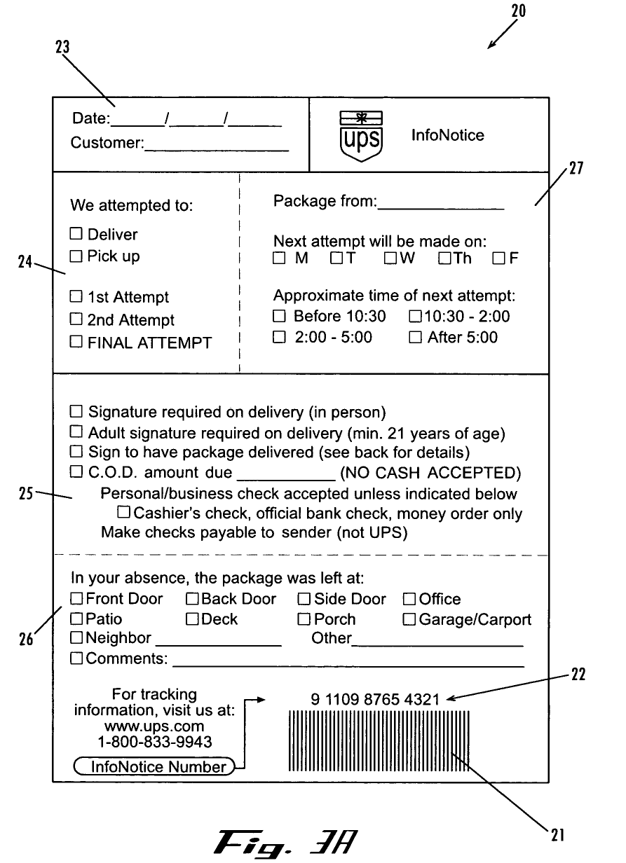

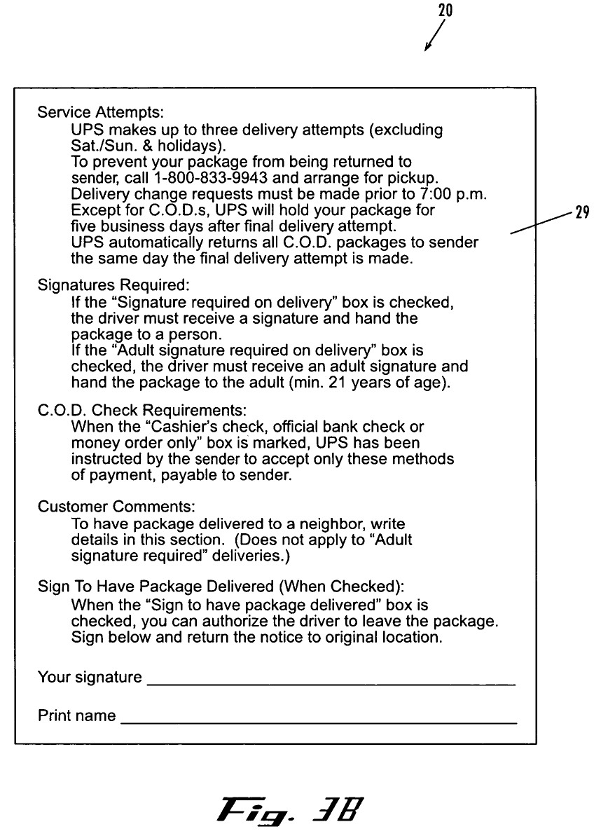

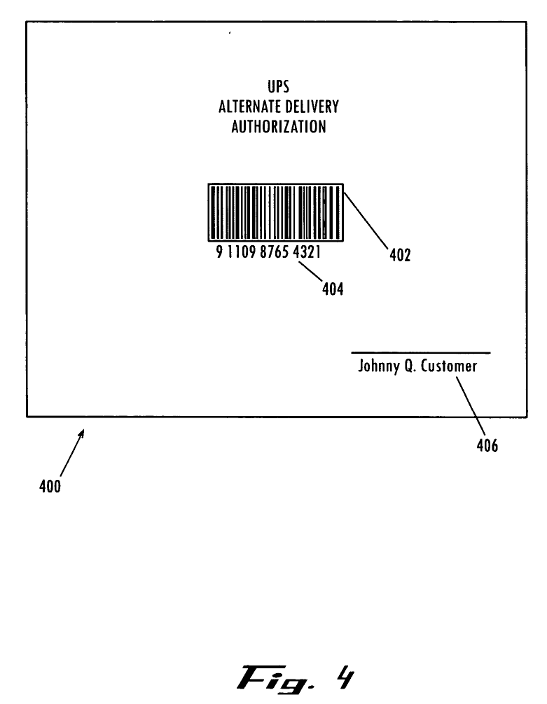

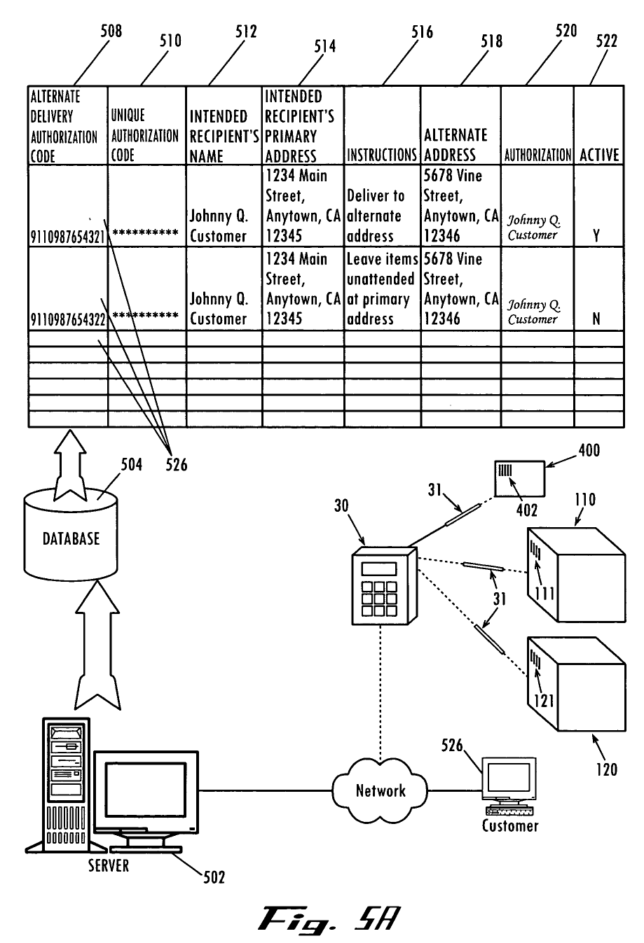

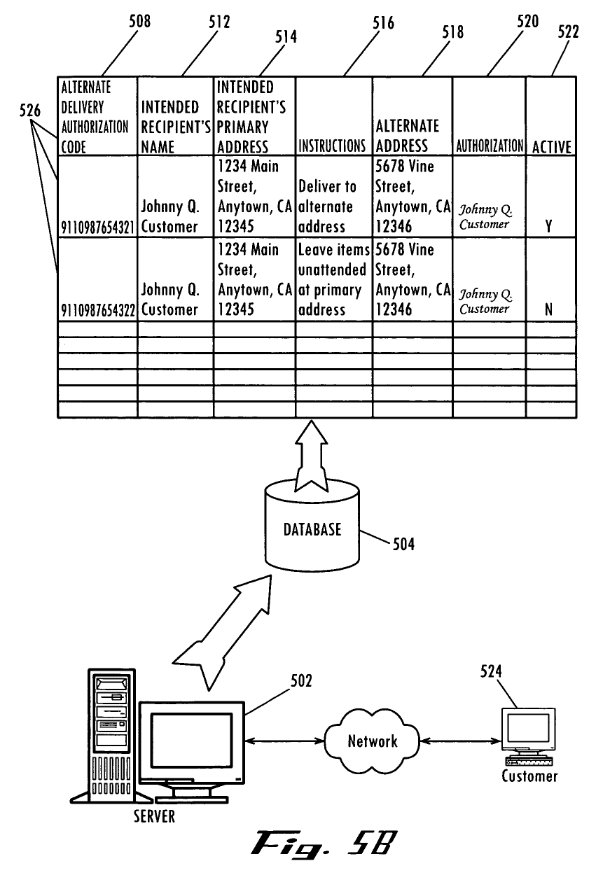

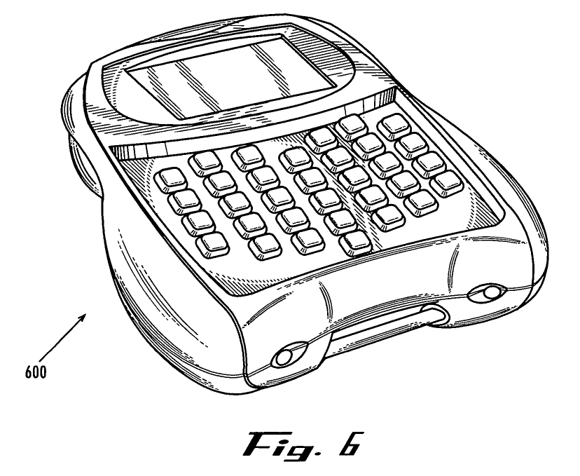

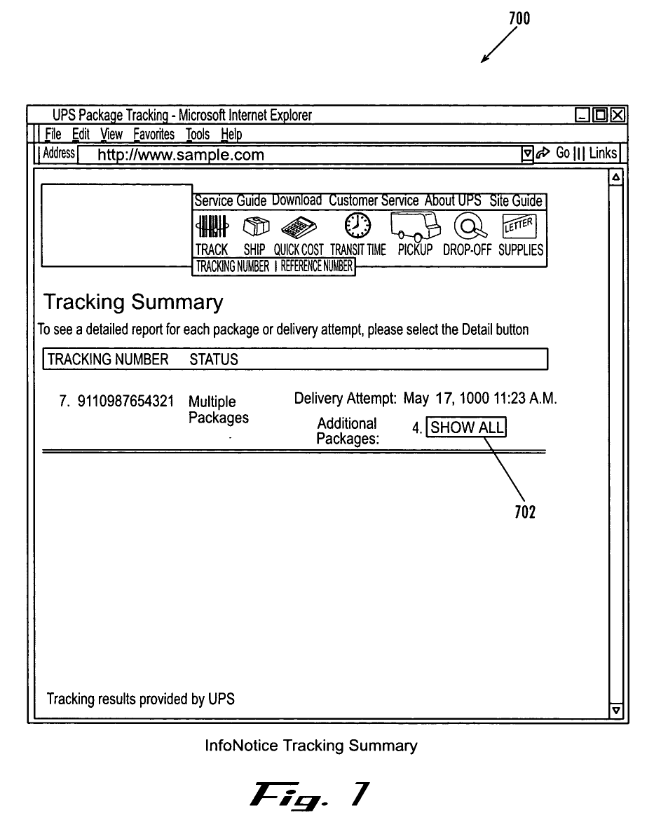

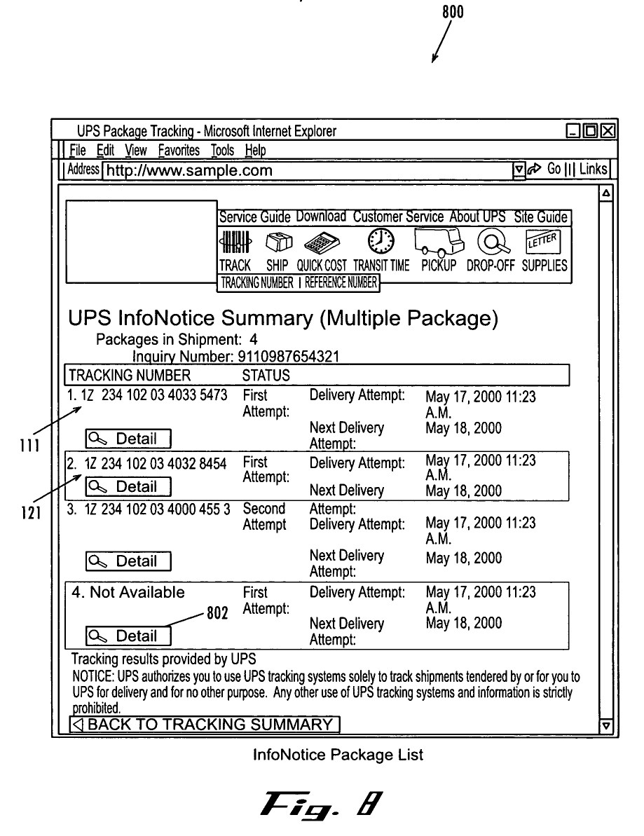

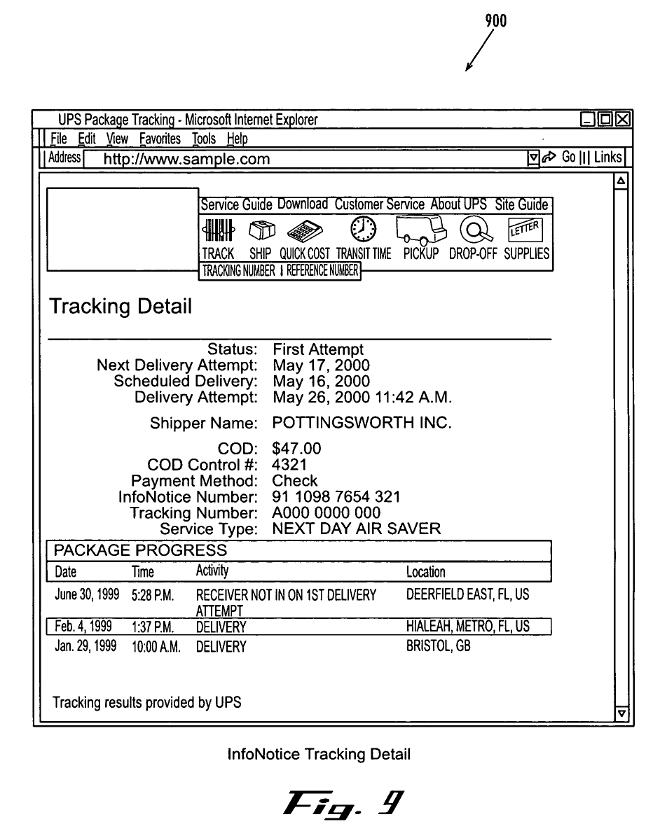

FIG. 8 shows a typical exemplary web page, entitled “UPS InfoNotice Summary (Multiple Package)”, which shows more details of the four parcels shown related to notice code number 9110987654321. As may be seen, such details include the package tracking number (a.k.a. the “item code”) for the individual packages, with the two exemplary parcel tracking numbers 111, 121, from FIGS. 2A and 2B denoted as being shown as the first two packages in this list. As may also be seen, other package-related data is shown which is of informational value, such as when the delivery attempt was made, how many delivery attempts have been made, etc. Note that if further detail is required, the customer can select (or “click on”) the hyperlink 802, to access a web page such as shown in FIG. 9.

FIG. 9 is a web page 900 that shows many details relating to a certain particular parcel. As may be understood, such information can be helpful to a customer. As may be seen, this page, entitled “Tracking Detail”, shows the status as “First Attempt”, the next delivery attempt as May 17, 2000, the original scheduled delivery as May 16, 2000, etc. The customer may also specify separate, independent actions for each parcel related to a unique delivery notice code. For instance, if four parcels are associated with one delivery notice (and the delivery notice code), then the customer may specify, for example, an alternative delivery location for one parcel (i.e., a “Delivery Change Request”), return to sender for another parcel, redelivery for yet another parcel, and “will call” for the last parcel.

FIGS. 10A, 10B, 10C and 10D are screen-shots showing the ability to modify the delivery status of an individual parcel, in this case a delivery change request.

FIG. 11 shows a process 1100 under the present invention in which the tracking system 10, 202 is facilitated through the use of the Internet.

FIG. 12 is a flow chart of a process 1200 in which the delivery notice is used by the customer in order to access a toll free number such as a “1-800” number.

FIG. 13 is a flow chart of a process in which an intended recipient provides alternative delivery instructions to a delivery service in an embodiment of the invention.

FIG. 14 is a flow chart of a process in which a delivery service delivers intended for an intended recipient at a first location in accordance with alternative delivery instructions in an embodiment of the invention.

### DETAILED DESCRIPTION OF THE INVENTION

Reference is now made to the figures, in which like numerals indicate like elements throughout the several views.

General Discussion

Generally described, under one aspect of the invention, a single unique delivery notice is left at the particular location. However, just before it is left, this notice is “linked” to the parcel(s) that were undeliverable. This can be done by, for example, a handheld portable data acquisition device that includes a conventional scanning or reading means, allowing information to be read from the delivery notice as well as labels on the parcels, and stored on the handheld portable data acquisition device. It also may be done by merely writing down the human readable notice code and the human-readable item codes on the parcels and associating the item codes with the notice code. If ten parcels were undeliverable, only one delivery notice is left behind, but it is “linked” to all ten packages.

The intended recipient can then contact the delivery service via the Internet (or other suitable network) or by phone, by using information provided on the delivery notice. By providing the delivery service with unique information from the delivery notice, the intended recipient can get valuable information regarding the undelivered parcels. Such information may include, for example, shipper name, how many packages from each shipper, time of attempted delivery, COD status, etc. Arrangements can then be made to have the package(s) redelivered, held at a local operation center (i.e., “will call”), redirected, or returned.

Additionally, the intended recipient may have established a personal profile of information on the delivery service's website. Such information may include, for example, instructions and authorization for the delivery service to deliver parcels to an alternative delivery location. For example, the delivery service may be instructed by information in the profile to redirect any parcels shipped to the intended recipient's home address during the work week to be delivered to the intended recipient's business address. Additional profile instructions may include an email address for the intended recipient so that an email is sent to the intended recipient, or their designee, when a delivery is attempted at a certain location. This email may include, for example, the notice code and a hyper-link to the delivery service's website so that the intended recipient may update their personal profile thereby instructing the delivery service to take certain actions regarding the parcels that were attempted to be delivered. For example, the intended recipient may instruct the delivery service to have the parcel(s) redelivered, held at a local operation center, redirected, returned, etc.

The intended recipient may also provide in their personal profile an authorization for the parcel(s) to be delivered or redelivered without requiring the delivery service to acquire a confirming signature at the delivery location. A user's personal profile may include a “signature on file.” This allows the delivery service to make deliveries for that customer at the location designated by the customer without having to obtain a signature at the delivery location. A unique identifier is assigned to the customer's “signature on file.”

In one embodiment, indicia may be located at the delivery location such that it can only be obtained by the delivery service if the delivery service actually goes to the delivery location, thus confirming the delivery service's presence at the delivery location and providing evidence of the delivery or attempted delivery of the parcel(s). The indicia is the same or corresponds to the unique identifier that has been assigned to the customer's “signature on file” or alternate delivery information in the customer's personal profile. For instance, the indicia may be a barcoded label that is the same as the unique identifier or it may be an encoded RFID device. As a temporary or short-term solution, the barcoded label may be printed on a computer printer that can be left at the customer's preferred delivery location so that it can be scanned by the delivery service's agent when making a delivery. For a more long-term solution (for instance, if the customer always wants their parcels left without having to obtain a signature at the delivery location), a placard or card bearing the indicia may be provided by the delivery service and mounted at the intended recipient's preferred delivery location.

Likewise, a customer of the delivery service may establish an alternate delivery location in their personal profile. The personal profile will contain an address for the alternate delivery, as well as some form of authorization. A unique alternate delivery identifier will be assigned to the alternate address and authorization. An indicia is provided at the intended recipient's delivery location. This indicia is associated with or is the same as the alternate delivery identifier. For instance, the indicia may be a barcoded label that is the same as the alternate delivery identifier or it may be an encoded RFID device. As a temporary or short-term solution, the barcoded label may be printed on a computer printer. The printed barcode may be left at the customer's preferred delivery location so that it can be scanned by the delivery service's agent when making a delivery. For a more long-term solution a placard or card bearing the indicia may be provided by the delivery service and mounted at the intended recipient's preferred delivery location.

The Overall System

Reference is now first made to FIG. 2A, which is an illustrative view of the various data connections between various elements of the overall system 10 according to an embodiment of the present invention. The system 10 includes a delivery notice 20, having a delivery notice code 21 thereon, a data acquisition device 30 and a server 40. The data acquisition device may have a scanning element 31, as shown, such as, for example, an RFID reader or a barcode scanner. In other embodiments a data acquisition device 30 may not be used and data may be acquired about the parcel or the delivery notice 20 merely by writing down human readable information about the delivery notice 20 and the parcel(s). As discussed in detail later, in an alternate embodiment the system can also include a parcel delivery car 50. Also as discussed in detail later, the system can also include an Internet 200 connection or other suitable network connection to provide access by customers (a.k.a. “users”) to typical computers 300, or can include the use of a call center 1000.

The customer may be able to establish a personal profile on the delivery service's website such that the delivery service will follow certain “rules” in that delivery of a parcel such as, for example, delivering the parcel to an alternative delivery location such as a business address, home address, or a retail postal facility (for example, The UPS Store, etc . . . ) Establishment of such a personal profile may be facilitated by use of the Internet. The intended recipient may also be able to designate in their profile that the delivery service send an email to a certain email address when an attempted delivery is made for a parcel for that intended recipient. The email may include, for example, information about the parcel to be delivered and information about the delivery notice 20, such as the delivery notice code 21, so that the intended recipient may access the delivery service's website and provide further direction to the delivery service regarding the disposition of the parcel(s).

Further, as previously described herein, the profile may also include a “signature on file” authorization that allows the delivery service to make a delivery at a location designated by the customer without having to obtain a signature at that location confirming the delivery.

Reference is also made to FIG. 2B, which is an illustrative view of the various data connections between various elements of another embodiment of the overall system 202 of the present invention. The system 202 includes a delivery modification authorization 400, having an alternate delivery authorization code 402 thereon, a data acquisition device 30 and a server 40. The alternate delivery authorization code 402 may be in the form of machine-readable and/or human readable indicia such as an encoded RFID device or a barcode. The data acquisition device 30 may have a scanning element 31, as shown, such as an RFID reader or a barcode scanner. In other embodiments a data acquisition device 30 may not be used and data may be acquired about the parcel or the delivery modification authorization 400 merely by writing down human readable information about the delivery modification authorization 400 and the parcel(s). As discussed in detail later, in an alternate embodiment the system can also include a parcel delivery car 50. Also as discussed in detail later, the system can also include an Internet 200 connection or other suitable network connection to provide access by customers (a.k.a. “users”) to typical computers 300, or can include the use of a call center 1000.

In one embodiment, the customer may be able to establish a personal profile that is accessed by or located on the delivery service's server 40 such that the delivery service will follow certain customer-defined “rules” in the delivery of a parcel to that customer. For example, in one embodiment, the personal profile may provide authorization and an alternative location for delivering parcels destined for the customer or the customer's primary location to an alternative delivery location such as a business address, home address, or a retail postal facility (for example, The UPS Store, etc.). In another embodiment, the intended recipient may also be able to designate in their profile that the delivery service send an email to a certain email address when an attempted delivery is made for a parcel for that intended recipient. The email may include, for example, information about the parcel(s) to be delivered so that the intended recipient may access the delivery service's website and provide further direction to the delivery service regarding the disposition of the parcel(s).

Further, in yet another embodiment, a customer's personal profile may also include a “signature on file” authorization that allows the delivery service to make a delivery at a location designated by the customer without having to obtain a signature at that location confirming the delivery. For instance, if the business rules of the delivery service require a signature at the time of delivery or an authorization (e.g., signed delivery notice) is required to leave items unattended, then the personal profile may include authorization such as, for example, a digital signature, password or code, thereby authorizing the delivery service to leave items intended for the customer unattended at the customer's location.

Currently, a delivery notice is left at a delivery location when at delivery attempt is made for an item by a delivery service and the delivery service's business rules prevent leaving the items unattended (e.g., an unsafe area). The delivery notice may provide a signature location where the intended recipient may sign the delivery notice and leave it for the delivery service, thus authorizing the unattended delivery of the items at the next delivery attempt. The embodiments of this invention allow a customer to pre-authorize the unattended delivery of items at the delivery location. For instance, a customer may be alerted that they have items being sent to them via a delivery service either by the shipper or by the delivery service. The customer may access the delivery service through, for example, an Internet website, a 1-800 telephone number, etc., and establish or modify a personal profile, thus authorizing unattended delivery of the items. The customer is assigned a unique identifier corresponding to their authorization for unattended delivery.

In one embodiment, the customer accesses the server over a network suh as, for example, the Internet. The server is one that is controlled by the delivery service or one that the delivery service may access. The customer either establishes a new personal profile on the server or accesses their existing personal profile. The personal profile includes instructions for the handling of items that are intended for that customer at one or more addresses. In one embodiment, the customer may include an authorization for delivering items to an alternate location in the customer's personal profile, rather than the location indicated on the item. This alternate location authorization may be selectively applied to particularly chosen items, or it may be applied to all items that are intended for the customer at one or more addresses. A unique code is created for that alternate location authorization that corresponds to a database record that provides the alternate delivery location. The unique code corresponds to the alternate delivery authorization code 402 on the delivery modification authorization 400, or the unique code is the same as the alternate delivery authorization code 402.

In another embodiment, the customer may include an authorization for leaving items unattended at a delivery location in the customer's personal profile. In many instances, a delivery service is required to obtain a signature of a person at the delivery location as proof of delivery. Often, however, a person authorized to sign for the delivery may not be at the location, which necessitates the delivery service making another attempted delivery at the location. In many instances, the intended recipient may prefer that the delivery service leave the items at the location (e.g., on the front porch) without obtaining a signature, rather than attempt to re-deliver the items. In this embodiment, the customer may create a “signature on file” in their personal profile that serves as a pre-authorization for unattended delivery. This unattended delivery authorization may be selectively applied to particularly chosen items by the customer, or it may be applied to all items that are intended for the customer at one or more addresses. A unique code is created for that unattended delivery authorization that corresponds to a database record that provides the “signature on file.” The unique code corresponds to the alternate delivery authorization code 402 on the delivery modification authorization 400, or the unique code is the same as the alternate delivery authorization code 402.

The customer may then print a delivery modification authorization 400, having an alternate delivery authorization code 402 thereon, or have such a delivery modification authorization 400 delivered to them. The alternate delivery authorization code 402 is in the form of a machine-readable and/or human-readable indicia such as, for example, a barcode, encoded RFID device, etc. The delivery modification authorization 400 having an indicia thereon is left by the customer in a location accessible by the delivery service when a delivery is attempted. When the delivery service attempts delivery of items at the delivery location, separate indicia on each item is linked with the indicia on the delivery modification authorization. This linking is recorded by the delivery service and provides an authorization for the unattended delivery or alternate delivery of each of the items.

The Delivery Notice

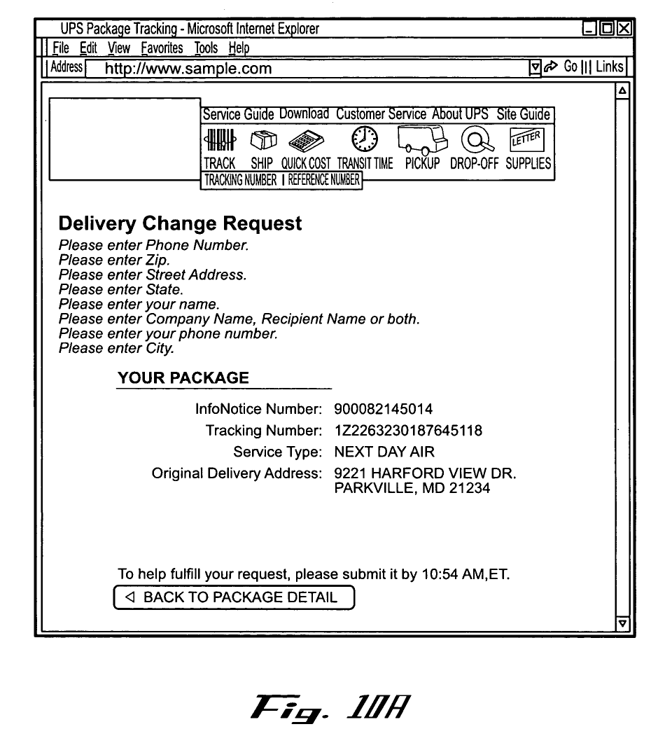

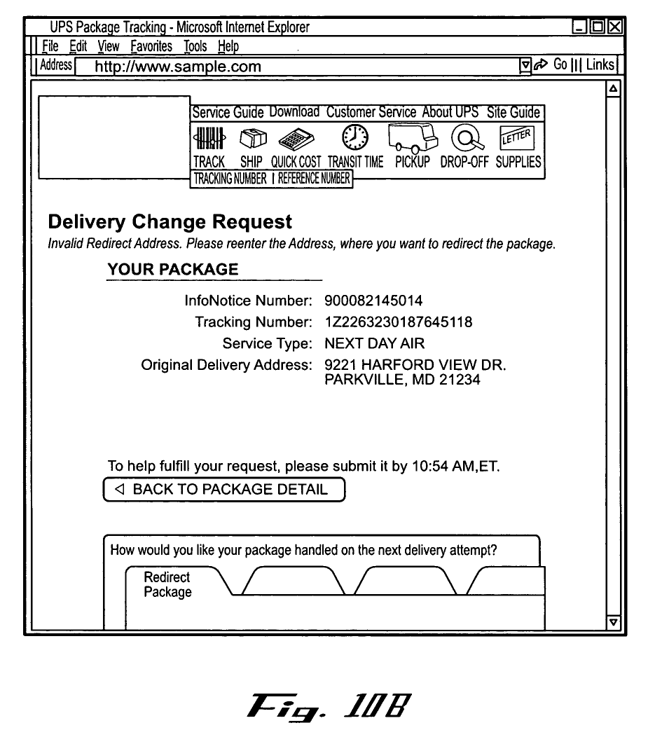

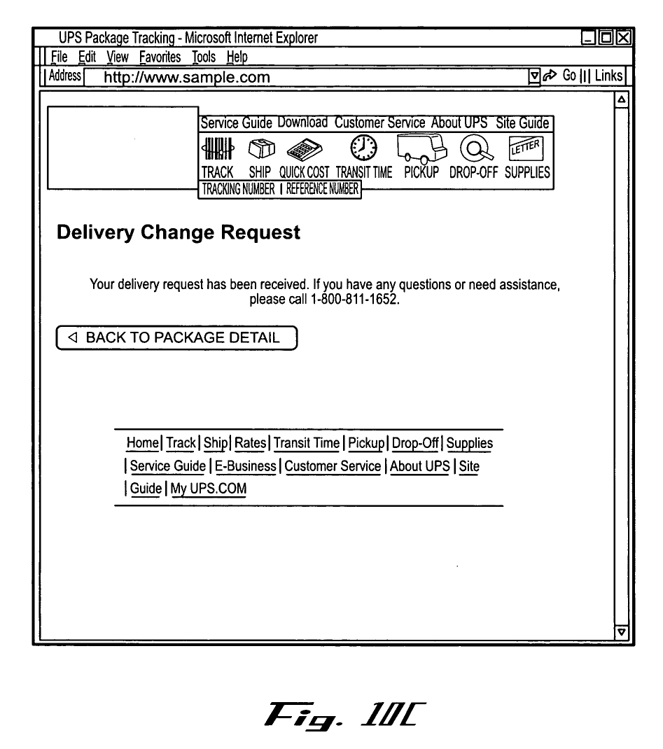

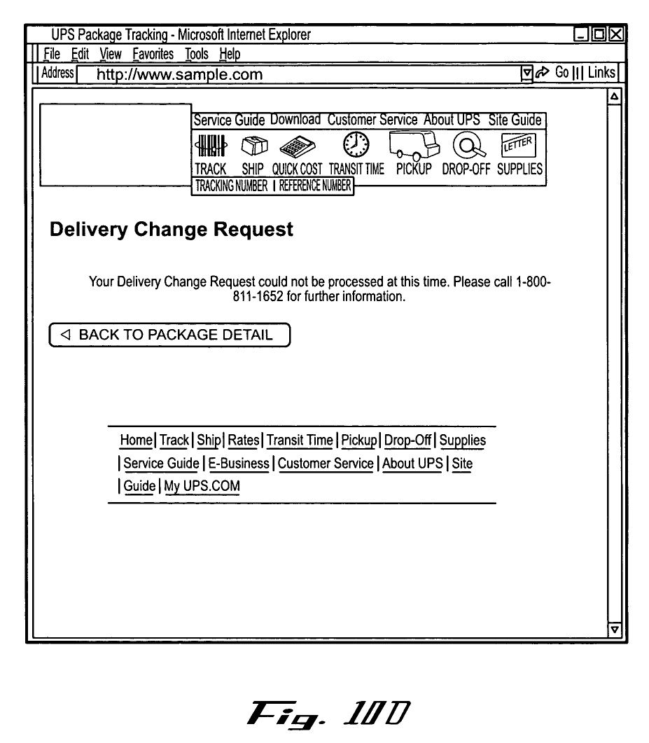

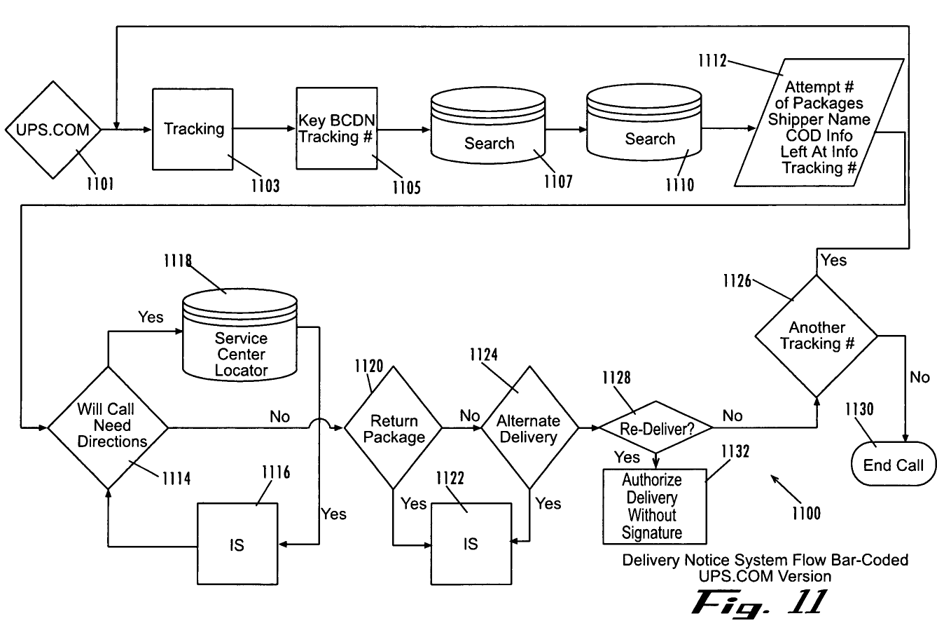

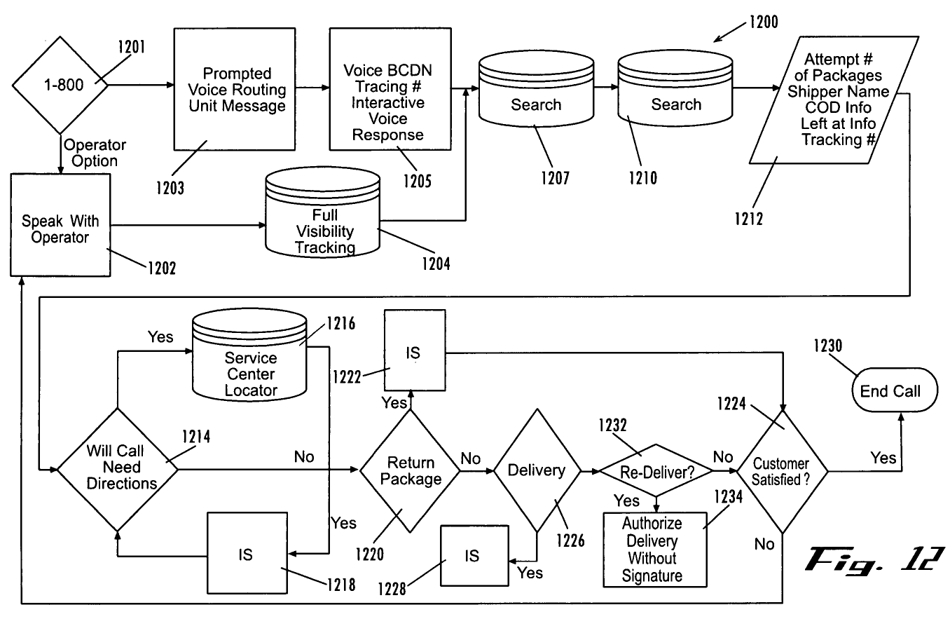

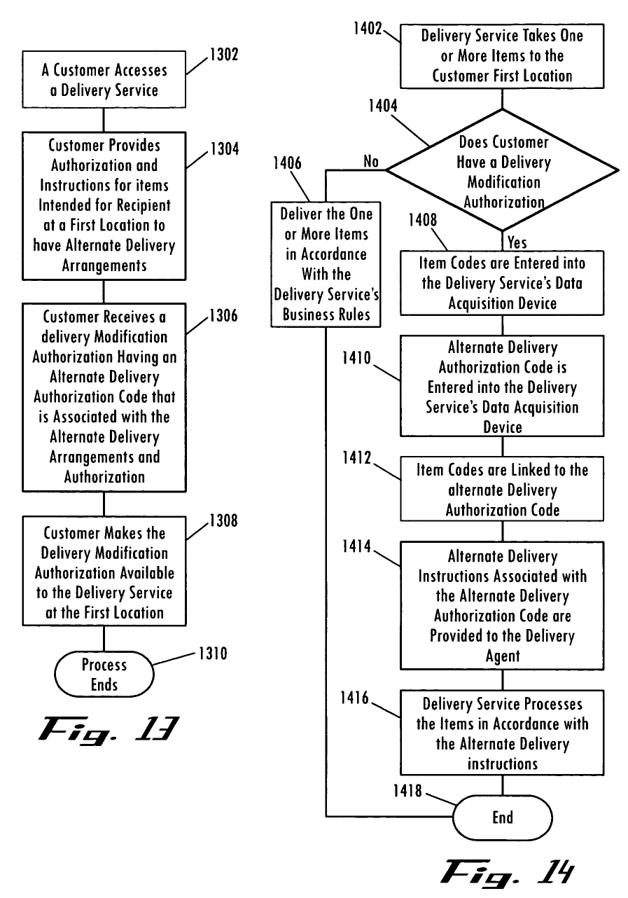

Reference is now made to FIGS. 3A and 3B, which combine to show one example of the type of delivery notices contemplated under an embodiment of the present invention, being a coded (e.g. bar coded) delivery notice 20. The notice in one embodiment is a piece of paper printed on both sides. The first side includes a machine-readable “first” delivery notice code 21, which corresponds to a human-readable “second” delivery notice code 22, which is in this case numerals, although it could be alphanumeric or any human readable format (in the embodiment shown the number is 9110987654321). Also included on the notice 20 is various other self-explanatory text on the notice in areas 23, 24, 25, 26, 27, and 29, with particular attention directed towards the text within area 26, which provides a telephone number to allow a person to call a telephone number to access tracking information at the web site shown.

In one embodiment the codes 21 and 22 are the same code or at least include common code portions, although the use of different although associated codes is also contemplated under the spirit and scope of the present invention. However, it should be noted that such human-readable and the machine-readable codes do not have to be the same codes, although they do need to be associated or “linked” in order to provide the needed link between the code read by the customer and the notice code scanned by the delivery agent 100. As an example, the two codes could be different but linked together back at, for example, a central server.

In other embodiments, the delivery notice may be in other forms such as an encoded RFID tag that is encoded with a machine-readable delivery notice code. The RFID tag may be associated with human readable information such as the human readable delivery notice code 22. Other forms of a delivery notice include, for example, an electronic transmission such as email, a page, telephone call, etc. directed to the intended recipient (or their designee), with such transmission including the human readable delivery notice code 22. The transmission may also include a link or other information such that the intended recipient may access a network to obtain additional information about the parcel(s) such as tracking information and alter the disposition of the parcel(s).

The Delivery Modification Authorization

Reference is now made to FIG. 4, which shows one example of a type of delivery modification authorization contemplated under an embodiment of the present invention, being a coded (e.g. barcoded) delivery modification authorization 400. The authorization in one embodiment is a piece of paper printed on one side. The paper includes a machine-readable (“first”) alternate delivery authorization code 402, which corresponds to a human-readable “second” alternate delivery authorization code 404, which is in this case numerals, although it could be alphanumeric or any human readable format (in the embodiment shown the number is 9110987654321). In other embodiments (not shown), there may be only one of the first alternate delivery authorization code 402 or the second alternate delivery authorization code 404. Also included on the authorization 400 may be other self-explanatory text such as, for example, a signature area 406 whereby the intended recipient may sign the delivery modification authorization 400. In other embodiments there may be more than one alternate delivery authorization code 402 and/or human-readable codes 404 on a single delivery modification authorization 400.

In one embodiment the codes 402 and 404 are the same code or at least include common code portions, although the use of different although associated codes is also contemplated under the spirit and scope of the present invention. However, it should be noted that such human-readable 402 and machine-readable codes 404 do not have to be the same codes, although they do need to be associated or “linked” in order to provide the needed link between the code read by the customer and the notice code scanned by the delivery agent 100. As an example, the two codes could be different but linked together back at, for example, a central server. Furthermore, in one embodiment the code 402 corresponds to certain instructions stored in a database that concern the items to be delivered. The code 402 may be the same or corresponds to one or more unique identifiers that have been assigned to an authorization in the customer's personal profile. These unique identifiers may be assigned, for example, to an authorization to deliver items intended for a certain recipient at a certain location to a second, alternate delivery location; or the authorization may be for the unattended delivery of items at a location.

In other embodiments, the delivery modification authorization 400 may be in other forms such as, for example, an RFID tag that is encoded with a machine-readable alternate delivery authorization code 402. The RFID tag may be associated with human readable information such as the human readable alternate delivery authorization code 404. Other forms of a delivery modification authorization 400 include, for example, a placard made of plastic, aluminum or other long-lasting materials that can be left by the intended recipient at a delivery location for the delivery service. The placard will include at least the machine-readable (“first”) alternate delivery authorization code 402, and may include the human-readable “second” alternate delivery authorization code 404.

FIGS. 5A and 5B are illustrations of exemplary systems and databases for establishing and linking an alternate delivery authorization code with a database record having personal profile instructions, in an embodiment of the invention. In FIG. 5A, a server 502 that is controlled by or accessible to a delivery service includes a database 504. The database is comprised of one or more records 526. Information contained within the database is entered by the customer 524 and/or the delivery service. Database information may be entered, retrieved and accessed by, for example, the data acquisition device 30. In the embodiment of FIG. 5A, each record 526 in the database 504 is comprised of at least five fields: the delivery authorization code 508, which is in either the form of the human readable delivery authorization code 404 or the machine-readable delivery authorization code 402 from the delivery modification authorization 400; a unique authorization code 510, which is a unique number, alphanumeric code or any other form of code that is assigned to an authorization for an alternate delivery when established by a customer; the name of the intended recipient (i.e., customer's name) 512; the primary address of the intended recipient (i.e., delivery location 514; an alternate delivery address 516 (if the alternate delivery authorization is for delivering items intended for delivery at the primary address 514 to an alternate location); an authorization 518 (e.g., a digital signature, secure password, code, etc. that is unique to the intended recipient); and an active indicator 520 that is to indicate whether the alternate delivery instructions are to be followed by the delivery service.

A delivery person, upon scanning or otherwise entering the information on the delivery modification authorization 400 will be provided with instructions 516 regarding alternate delivery for each of the packages 110, 120. The delivery person will also scan or otherwise enter the package code 111, 121 for each package 110, 120, which are then linked to the alternate delivery information 526 that is associated with that delivery modification authorization 400. Thus, the authorization for an alternate delivery is provided by the delivery modification authorization 400 and the information 526 associated with such delivery modification authorization 400.

The database shown in FIG. 5B is similar to the database shown in FIG. 5A; however, each record 526 in the database 504 is comprised of the delivery authorization code 508, which is in either the form of the human readable alternate delivery authorization code 404 or the machine-readable alternate delivery authorization code 402 from the delivery modification authorization 400, which also serves as the unique authorization code 510, which is a unique number, alphanumeric code or any other form of code that is assigned to an authorization for an alternate delivery when established by a customer; the name of the intended recipient (i.e., customer's name) 512; the primary address of the intended recipient (i.e., delivery location) 514; an alternate delivery address 516 (if the alternate delivery authorization is for delivering items intended for delivery at the primary address 514 to an alternate location); an authorization 518 (e.g., a digital signature, secure password, code, etc. that is unique to the intended recipient); and an active indicator 520 that is to indicate whether the alternate delivery instructions are to be followed by the delivery service.

Though not explicitly shown in FIG. 5B, the information in the database 504 of FIG. 5B may be accessed, entered and retrieved by, for example, the data acquisition device 30 as shown in FIG. 5A.

The Packages

Referring again to FIGS. 2A and 2B, an exemplary package 110 includes a machine-readable package code 111 (a.k.a. “item code”), which in one embodiment is a “tracking number” or “1Z” number as referenced by UPS, although obviously other package codes used to track or identify packages may also be used. The same is true for exemplary package 120 that includes a similar machine-readable package code 121. In both of these embodiments the machine-readable package code is in the form of visible indicia, although other non-visible means such as an encoded RFID tag, magnetic media, sound, texture, or the like may also be used without departing from the spirit and scope of the invention. In both these cases in these embodiments the indicia is a bar code, although other codes are contemplated without departing from the spirit and scope of the invention.

The machine-readable package codes 111 and 121 are configured to be read by a code reader such as a bar code scanner or an RFID reader such as are known in the art, although other code readers are contemplated without departing from the spirit and scope of the invention.

Data Acquisition Device

Continuing to refer to FIGS. 2A and 2B, the system 10, 202 according to an embodiment of the present invention also includes a data acquisition device 30 having a scanning element 31 (e.g., bar code reader, RFID reader, etc.) configured to scan the bar codes 21, 111, 121 and 402 discussed above. In other embodiments the data acquisition device 30 may include an RFID reader or have other devices capable of “reading” the respective types of notice codes 21, 402 and package codes 111.

The data acquisition device 30 in an embodiment of the present invention may be those such as are known under the mark “DIAD”, equipped with a suitable scanner 31 or other reader and loaded with the appropriate hardware and software suitable to perform the scanning or reading and data storage features noted below. Briefly stated, such scanning or reading capabilities include for example the capabilities to scan machine-readable codes such as bar codes or read an encoded RFID tag. The associated software and hardware include the capabilities of converting the readings from the scanner or reader to appropriate digital data for storage within the data acquisition device. The data acquisition device should also include appropriate hardware and software to allow such digital data to be transferred from the data acquisition device to an external storage means such as a centralized computer server 40 such as known in the art.

A typical DIAD as used by UPS is shown in FIG. 6. The DIAD 600, in various embodiments, may have wireless communications with the server 40, or communications with the server 40 may be accomplished through a wireless communications device mounted in the vehicle 50 in which the DIAD 600 is placed, or information may be passed to and from the server 40 via a network or direct connection when the DIAD 600 is placed in a communications device (e.g., at the end of the day a data exchange occurs between the DIAD 600 and the server 40).

Data acquisition may also be accomplished in other ways that do not necessarily involve or require a data acquisition device 30 such as, for example, writing down the human readable notice code and the human readable package code(s) that are to be associated with the delivery notice. These codes may later be entered into a computer database such that the notice code and the parcel code(s) are linked and the parcel(s) may be tracked and their disposition altered.

Server

Such a server 40 as noted above can receive data from the data acquisition device 30 through a direct route such as shown in the dotted lines of FIGS. 2A, 2B and 5A, or through an indirect route also as shown in dotted line through hardware associated with the driver's package car 50 in FIGS. 2A and 2B. It should be understood that the type of connecting hardware or software is not essential to the present invention; many different types of data acquisition devices and transfer means may suffice.

Information on the server 40 is used to provide information for the intended package recipients through use of the Internet 200 (or other suitable network) or alternated by use of telephone call centers such as 1000. As discussed in later detail, the intended package recipients provide the human-readable delivery notice code 22 over the Internet or the telephone and receive information back about the undelivered parcel(s). Information on the server 40 is also provided to a delivery agent when the intended recipient has established alternate delivery arrangements on the server 40.

The server 40 is not necessarily a stand-alone server dedicated to the system 10. It may be a server that is already integrated into the delivery service's business. Furthermore, it may be comprised of one or more servers and the information utilized by the server 40 may be obtained from pre-existing databases developed in other areas of the delivery service's business.

The server 40 may also be utilized to send an electronic transmission to the intended recipient to notify them of the undelivered parcel(s). It may also allow an authorized intended recipient to modify certain information about the parcel(s), such as providing a means for a customer to authorize an alternate delivery by specifying an alternative delivery location, authorizing unattended delivery, returning the parcel(s) to the sender, schedule redelivery, or have the parcel held at a service center for pick-up.

The Delivery Agent

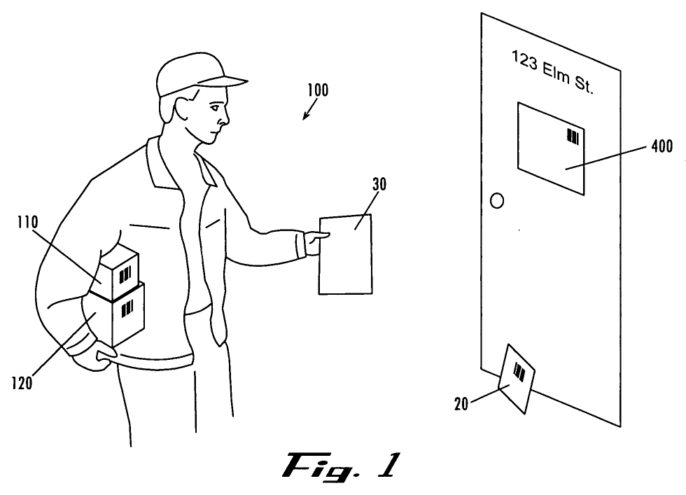

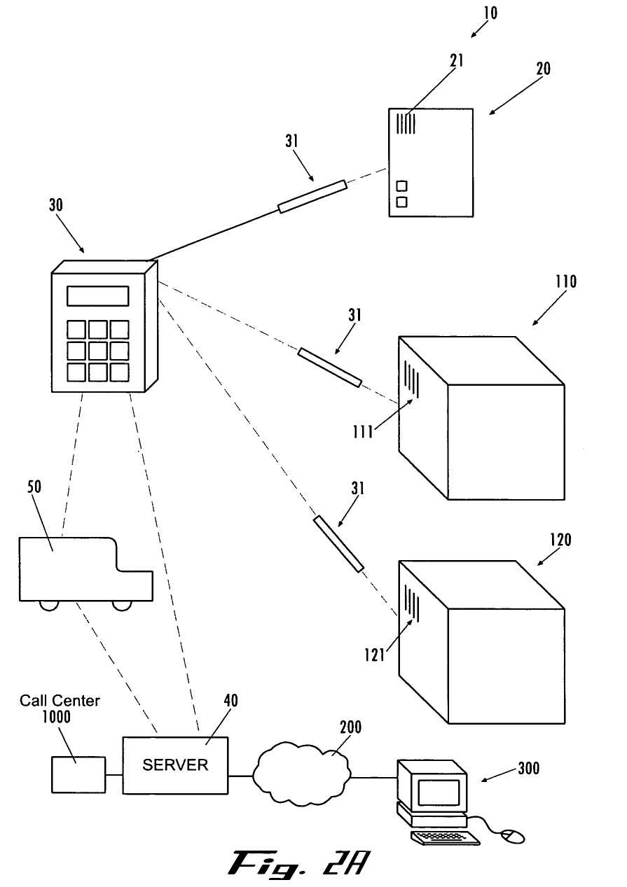

Reference is now made again to FIG. 1, which is an illustrative view of a delivery agent 100 holding a plurality of parcels 110, 120, at the door of a typical address, 123 Elm Street. In the view shown, as the parcels could not be delivered according to the agent's delivery rules, the agent has obtained information from a delivery notice 20 by use of a data acquisition device 30 or by otherwise recording such information, and has left the notice 20 at the address 123 Elm Street. Furthermore, a delivery modification authorization 400 has been left at the address by the intended recipient. The agent 100 will in this instance scan or otherwise enter the indicia 402 on the delivery modification authorization 400 with a data acquisition device 30, and then scan or otherwise enter the indicia 402 associated with the parcels 110, 120, thereby linking the delivery modification authorization 400 with the parcels 110, 120. The parcels 110, 120 will then be delivered in accordance with the delivery modification authorization 400, which may involve leaving the parcels 110, 120 at the address (unattended), retaining them for a redelivery attempt, retaining them for delivery at another location, pick up by the intended addressee, or further disposition as directed by the intended addressee. This will now be discussed in detail in conjunction with an example.

### EXAMPLE

It will first be assumed that a computer system from XYZ corporation is to be delivered in the form of two boxes, by a delivery agent 100 (working for a company such as, for example, UPS) such shown generally in FIG. 1, to a customer address at 123 Elm Street. It will be assumed that two parcels 110, 120, are to be delivered, with each parcel including a different machine-readable parcel code (a.k.a. “item code”) readable therefrom. It will also be assumed that a signature is required to leave the parcels at the customer's address, unless the customer has a “signature on file” in their personal profile and a delivery modification authorization 400 has been left at the intended addressee's location or other arrangements have been made.

It will also be understood that the delivery agent 100 will be equipped with at least a data acquisition device 30 and a delivery notice 20. Typically the delivery agent 100 will carry a pad of multiple delivery notices.

The coded (e.g., bar coded) delivery notice 20 shown in FIGS. 3A and 3B is one example of the type of delivery notices contemplated under an embodiment of the present invention. The delivery notice includes, but it not limited to, a machine-readable delivery notice code 21, a human-readable delivery notice code 22 (in the embodiment shown the number is 9110987654321). In one embodiment the codes 21 and 22 are the same code or at least include common code portions, although the use of different although associated codes is also contemplated under the spirit and scope of the present invention. As an example, the two codes could be different but linked together back at, for example, the central server.

The coded (e.g., bar coded) delivery modification authorization 400 shown in FIG. 4 is one example of the type of delivery modification authorizations contemplated under an embodiment of the present invention. The delivery modification authorization includes, but it not limited to, a machine-readable authorization code 402, which corresponds to certain instructions stored in a database that concern the items to be delivered, and, in some embodiments. a human-readable authorization code 404 (in the embodiment shown the number is 9110987654321). In one embodiment the codes 402 and 404 are the same code or at least include common code portions, although the use of different although associated codes is also contemplated under the spirit and scope of the present invention. As an example, the two codes could be different but linked together back at, for example, the central server.

Approach to Delivery Location

As noted, the delivery location is at 123 Elm Street. The delivery agent 100 (a.k.a. “driver”) such as shown in FIG. 1 will arrive at the 123 Elm Street address. The driver will then access or “pull up” the address on the data acquisition device 30, and will scan with scanner 31 the codes 111, 121 on both packages 110, 120, respectively. The driver will then press “Enter” on the data acquisition device 30. This may be understood as the machine scanning of a machine-readable “item code” or “parcel code”. The driver will then attempt delivery of the two parcels 110, 120.

Delivery Possible

If someone is at home, the parcels will be delivered, and a suitable entry is made in the data acquisition device 30 such as shown in FIGS. 1, 2A and 2B. The delivery notice 20 and/or the delivery modification authorization 400 are not used.

No Delivery Possible

If no one is at home, under the scenario presented above (a.k.a. the “predetermined rules”), the delivery agent 100 cannot enter a signature, so the delivery agent 100 makes an indication regarding the presence of the delivery modification authorization 400. If a delivery modification authorization 400 is present, then at that time the data acquisition device 30 will prompt the delivery agent 100 to obtain information from a delivery modification authorization 400 such as shown in FIGS. 1, 2B and 4. The delivery agent 100 then will scan, read or record the machine-readable authorization code portion 402 on the delivery modification authorization 400 with a device 31 capable of reading the machine-readable authorization code portion.

Unless such information is already entered, the driver can also fill out preliminary information such as the date, delivery attempt no., COD status, any other needed information, and will then press “stop complete” on the data acquisition device. This completes the creation of a delivery stop record, which, under one embodiment of the present invention, may include but is not limited to the following data fields: package delivery address, item code, delivery modification authorization code(s), time and date, consignee, COD information, etc.

At this point there has been a link between the delivery modification authorization 400 and the tracking numbers on the two packages. Information about the attempted delivery is then transferred from the data acquisition device 30 to the server 40. Alternatively, if information about the attempted delivery has only been recorded (e.g., written down) then the information may be entered into a data acquisition device 30 and transferred to the server 40 or it may be entered into a data entry device connected to the server 40. The server 40 then searches a database 504 for a record 526 that matches the alternate delivery authorization code 402 on the delivery modification authorization 400. When the record 526 is found, it is first determined if the alternate delivery instructions found in the record 526 are active. If the alternate delivery instructions are active, then the delivery instructions associated with the record are provided to the delivery agent 100. In one embodiment, the alternate delivery instructions are displayed on the data acquisition device 30.

As shown in FIGS. 5A and 5B, in one embodiment (FIG. 5B) the alternate delivery authorization code 508, as obtained from the delivery modification authorization 400, is a unique code by which the database 504 is indexed. Once a match between the authorization code 402 as obtained from the delivery modification authorization 400 and the alternate delivery authorization code 508 is made, the record 526 is read to determine if the alternate delivery instructions are active 522. If active, then the instructions 516, in one embodiment, are displayed to the delivery agent 100 via the data acquisition device 30. If the record 526 is not active, then no instructions 516 will be displayed to the delivery agent 100. The instructions 516 may include, for example, directions for the delivery agent 100 to leave the parcel(s) unattended at the delivery location, or for the delivery agent 100 to deliver the parcel(s) to an alternate location. The intended recipient provides authorization 520 for the delivery agent 100 to follow the instructions 516 through the use of a code, digital signature, or other forms of verifiable authorization 520, as are known in the art.

If the instructions 516 are for the delivery of the parcel(s) at an alternate location, then the parcel(s) will be returned to the delivery vehicle and, if the alternate address is on the delivery agent's route, delivered to the alternate address. If the alternate location is not on the delivery agent's route, then the parcel(s) will be returned to the delivery service's operations center and re-routed to the alternate address. If the instructions 516 indicate that the intended recipient has authorized unattended delivery of the parcel(s), then the parcel(s) will be left at the intended recipient's location and no confirming signature will be obtained at that location.

In another embodiment as shown in FIG. 5A, each authorization record 526 in the database 504 has a unique authorization code 510 that is separate and distinct from the authorization code 508 found on the delivery modification authorization 400. The authorization code 508 of the delivery modification authorization 400 is correlated to the unique authorization code 510 within the database record. This correlation allows the alternate delivery instructions 516 associated with the authorization code 508 of a delivery modification authorization 400 to be displayed to the delivery agent 100. The parcel(s) will then be delivered in accordance with the instructions 516, as provided above.

The Personal Profile

In many instances, an intended recipient (a/k/a “customer”) may be made aware of the upcoming delivery of items by either the delivery service or the shipper. In other instances the customer may not be aware of the attempted delivery of items until coming home and finding a delivery notice at their address. In either circumstance, when the customer desires to make alternative delivery arrangements for the items, he or she has the option of using at least two modes of communication with the delivery service (e.g. UPS); through a 1-800 line, or through the Internet at, for example, UPS.COM, MYUPS.COM, or another suitable location.

The Internet Connection

The customer may receive an email or some other form of electronic transmission that a parcel delivery has been attempted or will be attempted. If the delivery has already (unsuccessfully) been attempted, the email will contain the delivery notice number and a hyper-link to the delivery service's website (such as UPS.COM or MYUPS.COM). If delivery has not yet been attempted, the email may only contain information about the impending delivery or it may contain a hyper-link to the delivery service's website and tracking system.

Under this mode of communication, the customer goes to UPS.COM or MYUPS.COM (or any other suitable Internet or network location) either through a hyper-link provided in an email or by accessing the website through a web-browser. The customer may have already created a personal profile of delivery preferences at such a website or the customer may now create such a profile. The profile may indicate, for example, a preferred alternate delivery location and authorization for such an alternate delivery, an email address for notifying the customer of an attempted delivery, a “signature on file” authorizing delivery at a location without a confirming signature, etc. Otherwise, the customer may or may not choose to establish a personal profile. The customer's personal profile information will be stored on the server so that the customer is not required to re-enter the profile information. The customer may activate or deactivate alternate delivery arrangements, as desired. If delivery has been attempted and the parcels have been associated with a delivery notice, then the customer may use the delivery notice code to make arrangements for alternate delivery. Otherwise, if the parcels are not associated with a delivery notice, then the customer may make or change arrangements for alternate delivery or activate or deactivate prior-made alternate delivery arrangements by accessing the delivery service's website.

Parcels Associated with a Delivery Notice

When ready to access information about parcels associated with a delivery notice, the customer clicks on a “delivery notice” or other suitable icon or location. Such clicking would direct the customer to a web page that will prompt for and allow entry of the delivery notice number.

By virtue of the above-referenced “link” between the delivery notice and the package information (which can be done through suitable database manipulation and control as known in the art) the customer can then be told by the delivery service that the customer has, for example, two packages which were previously undelivered. Any other relevant information can also be provided, such as information noting that the delivery service does not accept cash, and if a COD request is made, how and to whom payment should be made.

If desired, the individual parcel(s) can be tracked through current means associated with a tracking number.

At that time, the customer could then click on an icon associated with each individual parcel allowing the customer to be linked to suitable locations which would allow the customer to have the delivery service leave the parcel at a local delivery center, the customer could refuse the parcel, the customer could ask for future delivery, the customer could authorize delivery without a signature, or the customer could initiate a “delivery change request”, in which the customer could key in a new address. Such a new address could be automatically checked for validity by the delivery agent software by suitable means, and if the address is valid the parcel could be sent to the new address. Furthermore, the customer could be provided with a list of commercial mail locations (e.g., The UPS Store, etc.) near the customer's home or business location. The customer may select one of these proposed locations and have the parcel delivered by the delivery service at such location or the customer may be able to enter an address of another location for delivery of the parcel.

Reference is now made to exemplary web pages that may be used to facilitate such interaction between the customer and the delivery service. FIG. 7 shows a typical exemplary web page that the customer would see after entering the delivery notice code 22 which the customer read from the notice 20, which in this case is 9110987654321. The page, which could be referenced as the “Tracking Summary” page, shows that the delivery was attempted on May 17, 2000, at 11:25 a.m., and that four packages were in the attempted delivery. The customer can use the hyperlink at 702 to view that shown in FIG. 8.

FIG. 8 snows a typical exemplary web page, entitled “USP InfoNotice Summary (Multiple Package),” which shows more details of the four parcels shown related to the notice code number 9110987654321. As may be seen, such details include the package tracking number (a.k.a. the “item code”) for the individual packages, with the two exemplary parcel tracking numbers 111, 121, from FIGS. 2A and 2B being denoted being shown as the first two packages in this list. As may also be seen, other package-related data is shown which is of informational value, such as when the delivery attempt was made, how many delivery attempts have been made, etc.

For example, the first package listed has a package tracking number 111 of 1Z2341020340335473, the notice is associated with its first delivery attempt, this delivery attempt was May 17, 2000 at 11:23 a.m., and its next delivery attempt will be at May 18, 2000.

The second package listed has a package tracking number 121 of 1Z2341020340328454, the notice is associated with its first delivery attempt, this delivery attempt was May 17, 2000 at 11:23 a.m., and its next delivery attempt will be at May 18, 2000.

The third package listed has a package tracking number of 1Z2341020340004553, the notice is associated with its second delivery attempt, this delivery attempt was May 17, 2000 at 11:23 a.m., and its next delivery attempt will be at May 18, 2000.

The fourth (and last) package listed has a package tracking number which is unavailable, the notice is associated with its first delivery attempt, this delivery attempt was May 17, 2000 at 11:23 a.m., and its next delivery attempt will be at May 18, 2000.

As noted above, two attempts have been made to deliver the third package. It may be understood that it may also be possible that this package may have another earlier-in-time delivery notice associated with it corresponding to that earlier delivery attempt. If the customer uses the earlier-in-time delivery notice, then the same, most current, parcel information will be shown to the customer for the parcels associated with the earlier-in-time delivery notice.

Note that if further detail is required, the customer can use or “click” on the hyperlink 802, to access a web page such as shown in FIG. 9.

FIG. 9 is a web page 900 that shows many details relating to a certain particular parcel. As may be understood, such information can be helpful to a customer. As may be seen, this page, entitled “Tracking Detail”, shows the status as “First Attempt”, the next delivery attempt as May 17, 2000, the original scheduled delivery as May 16, 2000, etc.

FIG. 10A illustrates a screen-shot of a web page in an embodiment of the invention that indicates the customer has not provided all of the required information when making a request through an Internet system that the package be delivered to an alternate location of a parcel.

FIG. 10B illustrates a screen-shot of a web page in an embodiment of the invention that indicates that the customer has provided an invalid city, state, or zip code entry when making a request through an Internet system that the package be delivered to an alternate location of a parcel.

FIG. 10C illustrates a screen-shot of a web page in an embodiment of the invention that indicates and confirms that the customer has successfully completed a Delivery Change Request when making a request through an Internet system that the package be delivered to an alternate location of a parcel.

FIG. 10D illustrates a screen-shot of a web page in an embodiment of the invention that indicates that the customer has unsuccessfully submitted a Delivery Change Request when making a request through an Internet system that the package be delivered to an alternate location of a parcel.

FIG. 11 shows a process 1100 under the present invention in which the tracking system 10, 202 is facilitated through the use of the Internet.

At step 1101, the customer begins access to the tracking system 10, 202 by accessing the URLs www.ups.com, or www.myups.com, or any other suitable location. As previously provided, the customer may be able to establish a personal profile on the delivery service's website that includes parcel delivery preferences.

At step 1103, the customer selects a particular tracking feature within the overall web site.

At step 1105, the customer enters the delivery notice code 22 that the customer read from the notice 20 (which in the case described above was 9110987654321), and selects the necessary icon or other selection to send the delivery notice code 22 to the tracking system 10.

At step 1107, the tracking system checks a database for delivery addresses.

At step 1110, the tracking system checks a database for customer records.

At step 1112, the tracking system presents certain information to the customer such as the information set forth in FIGS. 7-9. At this point, the customer may need no further information, such as in the case where the customer is aware of the time for the next delivery attempt. If this is the case, the customer will pass through steps 1120, 1124, 1126, 1128, and 1130, in many cases simply by moving to another web page or by logging off the Internet.

However, it may be possible that the customer would like to call upon the service center where the parcel(s) are being held until the next delivery attempt, instead of waiting for delivery. In this case, step 1114 allows the customer to execute a “Will Call” instruction to the tracking system 10. If the customer needs directions to the service center, step 1118 allows for a web-based search and location function, based upon, for example, the customer's ZIP code. The customer will provide a delivery notice, a delivery notice number and/or some form of valid identification in order to retrieve the parcel(s) from the service center.

Step 1116 is a step which includes the use of a IS (information systems) tool which allows the customer (through adequate protection) to modify the records of the tracking system 10, 202 relative to the item. In this case, if a “Will Call” is placed on the item, the item is to be held at a designated service center and step 1116 modifies the records of the tracking system 10, 202 to so reflect this instruction.

If the customer wants to return the package at decision step 1120, step 1122 is selected which allows for the records of the tracking system 10, 202 to so reflect this instruction.

If the customer does not want to return the package, but wants to attend to alternate delivery at step 1124, step 1122 is selected, which as discussed above in reference to step 1116, allows for the records of the tracking system 10, 202 to so reflect this instruction.

If the customer wants the delivery service to re-deliver the parcels at the customer's desired delivery location, but the customer wants to authorize the delivery service to make such a delivery without having to obtain a signature confirming delivery at the customer's desired delivery location, then step 1128 is selected. Step 1132 allows an intended recipient to authorize the delivery of the parcel(s) without requiring the delivery service to obtain a signature.

If at decision step 1126 the customer wishes to enter another notice code, the customer is redirected to step 1103. If not, the process (a.k.a. “call”) is over.

The 1(800) Connection

As noted elsewhere, the customer will have a 1(800) telephone number provided by the delivery notice. Speech recognition software or prompts for entry of telephone keypad signals can allow a customer to have the delivery service leave the parcel at a local delivery center, to allow the customer to refuse the parcel, allow the customer to request ask for future delivery, or to make a “delivery change” request. The customer will also have the ability to be opted out to a live operator if so desired.

Reference is now made to FIG. 12, which is a flow chart of a particular process 1200 in which the delivery notice is used by the customer in order to access a toll free number such as a “1-800” number.

The first step in process 1200 is step 1201, in which the customer dials the toll free number and is connected. Typically the toll free number will be on the delivery notice.

If the customer wishes to speak to a live operator, step 1202 is executed, and full visibility tracking is provided to the customer at step 1204. This brings up information such as shown in FIGS. 7-9, but also additional information in the system that the operator deems needed. If full visibility tracking is not needed, step 1207 is reached.

If the customer does not elect to opt out of automatic features, the process goes to step 1203.

At step 1203, a process begins which requests the customer to speak their notice code such as “please speak your notice code clearly at the beep”.

At step 1205, the instructions given by the customer are interpreted and converted into information such as the notice code. The system then has the notice code and proceeds to provide information relative thereto as described further herein.

At step 1207, the tracking system checks a database for delivery addresses.

At step 1210, the tracking system checks a database for customer records.

At step 1212, the tracking system (through an automated menu-based response system) presents certain information to the customer such as the information set forth in FIGS. 7-9. At this point, the customer may need no further information, such as in the case where the customer is aware of the time for the next delivery attempt. If this is the case, the customer will pass through steps 1220, 1226, 1224, and 1230, in many cases simply by hanging up the phone.

However, it may be possible that the customer would like to call upon the service center where the parcel(s) are being held until the next delivery attempt, instead of waiting for delivery. In this case, step 1214 allows the customer to execute a “Will Call” instruction to the tracking system 10. If the customer needs directions to the service center, step 1216 allows for a telephonic-based search and location function, based upon, for example, the customer's ZIP code.

At step 1218, the “Will Call” instructions can be added to the system as discussed elsewhere.

If the customer wants to return the package at decision step 1220, step 1222 is selected which allows a corresponding update to the system.

If at step 1226, the customer wishes to elect future delivery or a delivery change request, step 1228 may be selected to update the system.

If the customer wants the delivery service to re-deliver the parcels at the customer's desired delivery location, but the customer wants to authorize the delivery service to make such a delivery without having to obtain a signature confirming delivery at the customer's desired delivery location, then step 1232 is selected. Step 1234 allows an intended recipient to authorize the delivery of the parcel(s) without requiring the delivery service to obtain a signature.

If at step 1224, the customer is not satisfied, the customer will be routed to step 1202 to speak with an operator. If at step 1224, the customer is satisfied, the customer can end the call.

Parcel(s) Not Associated with a Delivery Notice

If the customer becomes aware of the impending delivery of parcels before a delivery has been attempted or wants to otherwise have alternate delivery arrangements made for parcel deliveries, the customer may establish such alternative delivery arrangements on the delivery service's server and leave a delivery modification authorization 400 at their address (“first location”) having an alternate delivery authorization code 402 indicia that is linked with the item code(s) of the parcel(s). The alternate delivery authorization code 402 is associated with a database record, as previously described, that provides instructions for alternate delivery, such as an unattended delivery (without signature authorization) at the intended recipient's address or having the parcel(s) delivered to an alternate address. In this manner, the item code or each parcel is linked with an authorization for delivery arrangements that deviate from the business rules or normal course of action for the delivery service.

The process for a customer operates in the manner shown in FIG. 13. At Step 1302, the customer accesses a delivery service by, for example, Internet, telephone, etc. At Step 1304, the customer provides authorization and instructions for items intended for delivery by the delivery service to the customer at a certain location to have alternate delivery arrangements. At Step 1306, the customer receives a delivery modification authorization having an alternate delivery authorization code from the delivery service. At Step 1308, the delivery modification authorization is made available to the delivery service when delivery is attempted at the customer's (primary) location. The process ends at Step 1310.

The process for a delivery service operates in the manner shown in FIG. 14. At Step 1402, the delivery service transports the item(s) to the customer's (primary) location. At Step 1404, it is determined whether a delivery modification authorization is found at the customer's location. If a delivery modification authorization is not found, then at step 1406, delivery is made in accordance with the delivery service's business rules. The process then ends at Step 1418. If a delivery modification authorization is found, then at Step 1408, the item code from each parcel is then entered into the data acquisition device. At Step 1410, the unique indicia (a/k/a alternate delivery authorization code) found on the delivery modification authorization is entered into the delivery agent's data acquisition device. At Step 1412, each item code is linked to the alternate delivery indicia. This step may occur within the data acquisition device or it may occur after the data stored on the data acquisition device is transferred to another device (e.g., computer, server, etc.). At Step 1414, the alternate delivery instructions associated with the unique alternate delivery authorization indicia are provided to the delivery agent. At Step 1416, the delivery agent processes the items in accordance with the alternate delivery instructions. The process ends at Step 1418.

Discussion of Terms

It should be understood that the term “scan” should be interpreted generally to mean the machine reading of a machine-readable code. This may include the type of bar code “scanning” in which a user moves a stylus across a bar code, but could also be interpreted to mean the use of a snapshot or other image grab which is then analyzed for bar code or other code presence and decoding as known in the art. It could also generally refer to the reading of a machine-readable code such as by using an RFID reader to read a RFID tag.

It should be understood that the system contemplates the use of a number (a.k.a. “plurality”) of delivery notices, with each of the delivery notices including a machine-readable delivery notice code thereon, and each of said delivery notice codes being unique within the number of delivery notices used at least with respect to a subset of deliveries. This is not to say that the same delivery notice code may never be re-used, but it is preferred that the same delivery notice code would not be used for some amount of time to preclude the possibility of confusion. A delivery notice should also be understood to take many forms such as, for example, a piece of paper left at the intended recipients address, an RFID tag, an email notification, etc. It should be understood that the term “link” is used to denote an association between elements that can later be recalled. An “electronic link” between data includes the linking (with the appropriate linking software) of a “first” type of data (data in a first database field, e.g., delivery notice identification data) with a “second” type of data (data in a second database field, e.g., package identification data), such that the recall of the first type of data, when used with the appropriate linking software, allows for ready recall of the second type of data.

Alternatives

Note that the data acquisition device shown is used as an example, other data acquisition devices may be used under the invention or a data acquisition device may not be used and the delivery notice code and the packages code(s) may be entered into a data entry device connected to the server and associated on the server.

Conclusion

While this invention has been described in specific detail with reference to the disclosed embodiments, it will be understood that many variations and modifications may be effected within the spirit and scope of the invention as described in the appended inventive concepts.

What is claimed:

1. A method for modifying the delivery of a one or more unique items each intended for delivery at a first location and each having a unique identity and having a different item code readable therefrom, said method including the steps of:
A) providing a delivery modification authorization having a unique alternate delivery code thereon at said first location;
B) reading said alternate delivery code from said delivery modification authorization;
C) reading said item code from each of said one or more items;
D) linking said alternate delivery code with said item code from each of said one or more items;
E) providing a database having alternate delivery instructions and authorization for alternate delivery of said one or more items, said database accessible by said alternate delivery code;
F) reading said alternate delivery instructions from said database; and
G) delivering said one or more items in accordance with said alternate delivery instructions.

2. The method of claim 1, wherein providing a database having alternate delivery instructions and authorization for alternate delivery of said one or more items comprises providing a database having instructions for delivery of said one or more items to a second location and authorization for delivery of said one or more items to said second location.

3. The method of claim 1, wherein providing a database having alternate delivery instructions comprises providing a database having instructions for unattended delivery of said one or more items at said first location and authorization for unattended delivery of said one or more items at said first location.

4. The method of claim 1, wherein said alternate delivery code is a machine-readable indicia.

5. The method of claim 4, wherein reading said alternate delivery code from said delivery modification authorization includes scanning a barcode with a barcode reading device attached to a data acquisition device.

6. The method of claim 4, wherein reading said alternate delivery code from said delivery modification authorization includes reading an RFID device with a RFID reading device attached to a data acquisition device.

7. The method of claim 1, wherein said item code is a machine-readable indicia.

8. The method of claim 6, wherein reading said item code from each of said one or more items includes scanning a barcode from each item with a barcode reading device attached to a data acquisition device.

9. The method of claim 6, wherein reading said item code from each of said one or more items includes reading an RFID device from each item with an RFID reading device attached to a data acquisition device.

10. A method for modifying the delivery of one or more unique items each intended for delivery at a first location and each having a unique identity and having a different machine-readable item code readable therefrom, said method including the steps of:
A) providing a delivery modification authorization at the first location having a unique alternate delivery code thereon;
B) reading said alternate delivery code from said delivery modification authorization;
C) reading said item code from at least one of said items;
D) linking said alternate delivery code with said item code;
E) reading stored alternate delivery information regarding the item in response to receipt of a description of said one of said delivery modification authorization from a delivery agent; and
F) modifying delivery plans of said item based upon said stored alternate delivery information.

11. The method of claim 10, wherein reading stored alternate delivery information regarding the item in response to receipt of a description of said delivery modification authorization from a delivery agent comprises accessing a database having instructions for delivery of said one or more items to a second location and authorization for delivery of said one or more items to said second location.

12. The method of claim 10, wherein reading stored alternate delivery information regarding the item in response to receipt of a description of said delivery modification authorization from a delivery agent comprises accessing a database having instructions for unattended delivery of said one or more items at said first location and authorization for unattended delivery of said one or more items at said first location.

13. The method of claim 10, wherein reading said alternate delivery code from said delivery modification authorization includes scanning a barcode with a barcode reading device attached to a data acquisition device.

14. The method of claim 10, wherein reading said item code from at least one of said items includes scanning a barcode from each item with a barcode reading device attached to data acquisition device.

15. The method of claim 10, wherein reading said alternate delivery code from said delivery modification authorization includes reading an RFID device with an RFID reading device attached to a data acquisition device.

16. The method of claim 10, wherein reading said item code from at least one of said items includes reading an RFID device from each item with an RFID reading device attached to a data acquisition device.

17. A method for modifying the delivery a plurality of unique items each intended for delivery at a first location and each having a unique identity and having a different machine-readable item code readable therefrom, said method including the steps of:
A) providing a delivery modification authorization at said first location, said delivery modification authorization having a unique alternate delivery code thereon;
B) reading said alternate delivery code from said delivery modification authorization;
C) reading said item codes from each of said items;
D) linking said alternate delivery code with said item codes;
E) reading stored alternate delivery information regarding the items in response to receipt of a description of said delivery modification authorization; and
F) modifying delivery plans of said items based upon said alternate delivery information.

18. A method of altering the delivery of one or more items each having an item code and each intended for delivery at a first location having a delivery modification authorization with an alternate delivery code, comprising:
A) transporting said one or more items to said first location;
B) reading said item code from each of said one or more items;
C) reading said alternate delivery code from said delivery modification authorization;
D) using the alternate delivery code to access information about said one or more items wherein said information includes alternate delivery instructions for the one or more items; and
E) modifying the delivery plans of said one or more items based upon said alternate delivery instructions.

19. The method of claim 18, wherein said alternate delivery instructions include transporting said one or more items to a second location for delivery.

20. The method of claim 18, wherein said alternate delivery instructions include the unattended delivery of said one or more items at said first location.

21. The method of claim 18, wherein reading said alternate delivery code from said delivery modification authorization includes scanning a barcode with a barcode reading device attached to a data acquisition device.

22. The method of claim 18, wherein reading said item code from each of said one or more items includes scanning a barcode from each item with a barcode reading device attached to a data acquisition device.

23. A method of an intended recipient providing alternate delivery instructions and authorization to a delivery service for the delivery of one or more items, comprising:
contacting said delivery service;
providing one or more alternate delivery instructions related to the one or more items intended for delivery to said intended recipient at a first location to said delivery service;
authorizing said one or more alternate delivery instructions for execution by said delivery service; and
receiving a delivery modification authorization having at least one indicia from said delivery service, wherein each said indicia is associated with at least one of said one or more alternate delivery instructions.

24. The method of claim 23, wherein contacting the delivery service comprises accessing a delivery service website through an Internet connection.

25. The method of claim 23, wherein contacting the delivery service comprises contacting the delivery service through a telephone connection.

26. The method of claim 23, wherein providing one or more alternate delivery instructions related to the one or more items intended for delivery to said intended recipient at a first location to said delivery service comprises providing instructions for the delivery of said one or more items to a second location.

27. The method of claim 23, wherein providing one or more alternate delivery instructions related to the one or more items intended for delivery to said intended recipient at a first location to said delivery service comprises providing instructions for the unattended delivery of said one or more items to the first location.

28. The method of claim 23, wherein authorizing said one or more alternate delivery instructions for execution by said delivery service comprises an authorization provided by a digital signature.

29. The method of claim 23, wherein authorizing said one or more alternate delivery instructions for execution by said delivery service comprises an authorization provided by a password.

30. The method of claim 23, wherein receiving a delivery modification authorization having at least one indicia from said delivery service comprises printing a delivery modification on a printer.

31. The method of claim 23, wherein receiving a delivery modification authorization having at least one indicia from said delivery service includes an indicia comprised of a barcode.

32. The method of claim 23, wherein receiving a delivery modification authorization having at least one indicia from said delivery service includes an indicia comprised of an RFID device.

33. A method of modifying the delivery of one or more items each having an item code and each intended for delivery at a first location by a delivery service, comprising:
transporting the one or more items to the first location by a delivery agent;
reading the item codes from the one or more items;
reading a unique indicia from a delivery modification authorization found at the first location;
linking the item codes to the unique indicia;
accessing a database by said unique indicia, wherein said database has one or more database records containing alternate delivery instructions indexed by the unique indicia;
retrieving said alternate delivery instructions associated with said unique index; displaying said alternate delivery instructions to said delivery agent; and
modifying the delivery of said one or more items in accordance with said alternate delivery instructions.

45. The method of claim 33, wherein reading the item codes from the one or more items comprises reading one or more barcodes with a scanning device attached to a data acquisition device.

45. The method of claim 33, wherein reading the item codes from the one or more items comprises reading one or more RFID devices with a scanning device attached to a data acquisition device.

34-35. (canceled)

36. The method of claim 33, wherein reading a unique indicia from a delivery modification authorization found at the first location comprises reading one or more barcodes with a scanning device attached to a data acquisition device.

37. The method of claim 33, wherein reading a unique indicia from a delivery modification authorization found at the first location comprises reading one or more RFID devices with a scanning device attached to a data acquisition device.

38. The method of claim 33, wherein modifying the delivery of said one or more items in accordance with said alternate delivery instructions includes delivering said one or more items to a second location.

39. The method of claim 33, wherein modifying the delivery of said one or more items in accordance with said alternate delivery instructions includes leaving said one or more items unattended at said first location.

40. The method of claim 33, further comprising storing a record of the delivery of said one or more items in accordance with said alternate delivery instructions.

41. A method of delivering one or more items each having an item code to an intended recipient by a delivery service, wherein the intended recipient has indicated alternate delivery arrangements for the delivery of items shipped to the intended recipient, comprising:
A) providing an Internet website that may be accessed by the intended recipient;
B) allowing the intended recipient to enter certain alternate delivery information at said website, wherein such information is comprised of instructions for the delivery of the one or more items intended for the intended recipient at a first location and authorization information that authorizes the delivery service to deliver the one or more items in accordance with the alternate delivery information;
C) storing the intended recipient's alternate delivery information on a server and assigning a unique indicia to the stored alternate delivery information;
D) providing the intended recipient with a delivery modification authorization that includes said unique indicia;
E) receiving one or more items for delivery to the intended recipient at said first location;
F) transporting said one or more items to said first location by a delivery agent;
G) reading said item code from each of said one or more items;
H) reading said unique indicia from said delivery modification authorization;
I) linking said item codes from each of said one or more items to said unique indicia;
J) accessing said server and retrieving said alternate delivery information
K) displaying said alternate delivery information to said delivery agent; and
L) delivering said one or more items while adhering to the alternate delivery information.

42. The method of claim 41, wherein the alternate delivery information includes instructions for the delivery of said one or more items at a second location for said one or more items to be delivered to the intended recipient.

43. The method of claim 42, wherein the second location includes retail postal facilities.

44. The method of claim 41, wherein the alternate delivery information includes instructions for the unattended delivery of said one or more items at said first location.

45. The method of claim 41, wherein the alternate delivery information includes an intended recipient's email address so that the intended recipient may be notified of the alternate delivery of said one or more items.

46. A computer-readable storage medium containing a database of computer-readable information for modifying the delivery of one or more packages intended for a customer by a delivery service, said database accessible by a set of computer-executable instructions and said database containing database records, wherein each said database record is at least comprised of:
a unique identifier that is associated with a delivery modification authorization; and
alternate delivery instructions,
wherein a delivery modification authorization identifier is received into a computer device and said computer-executable instructions cause said database to be accessed and searched for a database record having a unique identifier that matches the delivery modification authorization identifier, and if such database record is found then the alternate delivery instructions for that database record are displayed to the delivery service.

47. A system for modifying the delivery of one or more items each having an item code and each intended for delivery at a first location by a delivery service, said system comprised of:
a data acquisition device, wherein said data acquisition device reads the item codes from the one or more items;
a delivery modification authorization found at the first location, wherein said data acquisition device reads a unique indicia from the delivery modification authorization and electronically links the item codes to the unique indicia;
a first database that is accessed by said unique indicia, wherein said first database has one or more database records containing alternate delivery instructions indexed by the unique indicia and said alternate delivery instructions associated with said unique indicia are retrieved from said first database and displayed on said data acquisition device; and
a second computer database, wherein said linked item codes and said unique indicia are stored.
